(19) United States
(12) Patent Application Publication
(10) Pub. No.: US 2006/0204828 A1
(43) Pub. Date: Sep. 14, 2006

(54) Method and apparatus for dielectric bonding of silicon wafer flow fields

(75) Inventors: Slobodan Petrovic, Scottsdale, AZ (US); Brett Vinsant, Hillsboro, OR (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ClearEdge Power, Inc., Hillsboro, OR (US)

(21) Appl. No.: 11/356,273

(22) Filed: Feb. 15, 2006

Related U.S. Application Data
(63) Continuation-in-part of application No. 11/322,520, filed on Dec. 30, 2005.
(63) Continuation-in-part of application No. 11/323,047, filed on Dec. 29, 2005.
(63) Continuation-in-part of application No. 11/323,076, filed on Dec. 29, 2005.
(63) Continuation-in-part of application No. 10/555,037.
(60) Provisional application No. 60/755,023, filed on Dec. 30, 2005.
(60) Provisional application No. 60/754,818, filed on Dec. 30, 2005.
(60) Provisional application No. 60/538,150, filed on Jan. 20, 2004.

(51) Int. Cl. H01M 8/02; H01M 2/08; B32B 9/00

(52) U.S. Cl. 429/38; 429/36; 428/688

(57) ABSTRACT

According to one embodiment of the invention a fuel cell can be configured so as to directly bond silicon substrate flow field plates directly to one another via a dielectric bond without allowing reactant gases to penetrate the flow field plates during operation of the fuel cell.

### CROSS-REFERENCES TO RELATED APPLICATIONS

The present application is a continuation-in-part application of U.S. patent application Ser. No. 10/555,037, filed on Oct. 27, 2005 and entitled “Fuel Cell System”, which is a national phase filing under 35 USC §371 of PCT application no. PCT/US2005/001618 filed on Jan. 19, 2005 entitled “Fuel Cell System”, which in turn claims the benefit under 35 U.S.C. §119(e) of U.S. provisional application 60/538,150 filed on Jan. 20, 2004, all of which are hereby incorporated by reference in their entirety and for all purposes. The present application is also a continuation-in-part of U.S. patent application Ser. No. 11/323,076 filed on Dec. 29, 2005 and entitled “Method and Apparatus for Carbon Coated Fuel Cell Electrode” which is hereby incorporated by reference in its entirety and for all purposes. The present application also claims the benefit under 35 U.S.C. § 19(e) of U.S. provisional application 60/755,023 filed on Dec. 30, 2005 and entitled “Wafer Metallization for Silicon Bipolar Plates Used in Fuel Cell” which is hereby incorporated by reference in its entirety and for all purposes. The present application is also a continuation-in-part of U.S. patent application Ser. No. 11/323,047 filed on Dec. 29, 2005 and entitled “Method and Apparatus for Metal Coated Silicon Fuel Cell Electrode” which is hereby incorporated by reference in its entirety and for all purposes. The present application also claims the benefit under 35 U.S.C. § 19(e) of U.S. provisional application no. 60/754,818 filed on Dec. 30, 2005 and entitled “Eutectic Bonding of Silicon Fuel Cell Electrodes” which is hereby incorporated by reference in its entirety and for all purposes. The present application is also a continuation-in-part application of U.S. patent application Ser. No. 11/322,520 filed on Dec. 30, 2005 and entitled “Method and Apparatus for Forming a Fuel Cell Flow Field with an Electrolyte Retaining Material” which is hereby incorporated by reference in its entirety and for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

One embodiment of the invention relates generally to fuel cells. For example, one embodiment relates to dielectric bonding used in fuel cells.

### BACKGROUND

Carbon flow field plates have commonly been used in the past to produce fuel cells. Namely, the flow field plates are configured from solid carbon and formed with a flow field pattern that helps to distribute reactant gases. Due to the physical nature of carbon, these fuel cell flow field plates fashioned from carbon are substantially thick and heavy.

One type of fuel cell that has proven effective in commercial environments is a proton exchange membrane fuel cell. Such fuel cells utilize a proton exchange membrane distributed between an anode and a cathode of the fuel cell. The anode can utilize hydrogen gas and a catalyst to ionize the hydrogen. As a result, the proton produced from the ionization of the hydrogen can be conveyed across the proton exchange membrane and the electron can pass through conductors and the fuel cell load to the cathode. At the cathode, the proton and electron can react with oxygen to produce water. Other reactant gases can be utilized as well in fuel cells.

Often, a membrane electrode assembly (MEA) is utilized as part of the fuel cell to provide the proton exchange membrane. The MEA often comprises a membrane holding the electrolyte and gas diffusion layers disposed on either side of the membrane. Such gas diffusion layers often take the form of a thin layer of carbon material. Such carbon material can be positioned on either side of the membrane to facilitate gas diffusion at the anode side and cathode side of the MEA, respectively.

Because opposing sides of the MEA are exposed to different reactant gases, it is necessary that the opposing sides of the MEA be sealed off from one another during operation so as to prevent any leakage of the reactant gases from the anode side to the cathode side and vice versa. In the past, this sealing has been accomplished by using a gasketing arrangement and by applying sufficient pressure against the opposing carbon plates to ensure that the carbon plates were pressed with sufficient force against the MEA and gasketing to prevent any leakage.

As a function of applying this significant pressure, the MEA or its components could become damaged. Particularly, the electrolyte layer could be exposed to too strong a pressure that would cause damage to the electrolyte.

The use of gaskets requires a manual assembly process that is time consuming, expensive, and inaccurate. Because gaskets are required to be assembled by hand, there is a significant investment in manpower. This consequently takes a significant amount of time and leads to human error in assembly. As a result, the reliance on gaskets to seal the fuel cell assembly is one of the more significant costs in assembling fuel cells today.

Thus, there is a need for a system that can overcome some of the deficiencies of such fuel cells that rely on solid carbon flow field plates and gasketing arrangements.

### SUMMARY

According to one embodiment of the invention, an apparatus is provided that comprises a first silicon substrate flow field plate for use in a fuel cell and configured to prevent transmission of a first reactant gas through the first silicon substrate; a second silicon substrate flow field plate for use in the fuel cell and configured to prevent transmission of a second reactant gas through the second silicon substrate; and a dielectric bonding material disposed between the first silicon substrate flow field plate and the second silicon substrate flow field plate.

According to another embodiment of the invention, a method is provided that comprises providing a first silicon substrate flow field plate for use in a fuel cell and configured to prevent transmission of a first reactant gas through the first silicon substrate; providing a second silicon substrate flow field plate for use in the fuel cell and configured to prevent transmission of a second reactant gas through the second silicon substrate; and disposing a dielectric bonding material between the first silicon substrate flow field plate and the second silicon substrate flow field plate.

Further embodiments of the invention will be apparent to those of ordinary skill in the art from a consideration of the following description taken in conjunction with the accompanying drawings, wherein certain methods, apparatuses, and articles of manufacture for practicing the embodiments of the invention are illustrated. However, it is to be understood that the invention is not limited to the details disclosed but includes all such variations and modifications as fall within the spirit of the invention and the scope of the appended claims.

### BRIEF DESCRIPTION OF THE DRAWINGS

FIG. 1 illustrates a sectional view of a fuel cell according to one embodiment of the invention;

FIG. 2 illustrates a block diagram of a fuel cell powering a load;

FIG. 3 illustrates a perspective view of a silicon flow field plate according to one embodiment of the invention;

FIG. 4 illustrates a top view of a flow field plate and a bonding material disposed on the flow field plate, according to one embodiment of the invention;

FIG. 5 illustrates a flow chart demonstrating a method of configuring a fuel cell, according to one embodiment of the invention;

FIGS. 6A, 6B, and 6C illustrate a flow chart demonstrating a method of configuring a fuel cell according to another embodiment of the invention.

### DETAILED DESCRIPTION

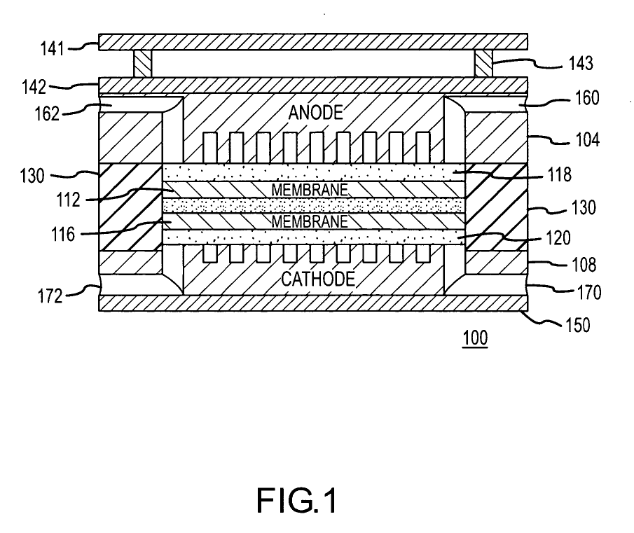

Referring now to FIG. 1, a new fuel cell system can be seen according to one embodiment of the invention. FIG. 1 shows a fuel cell system 100. The fuel cell shown in FIG. 1 utilizes a reactant gas that flows across the flow field plate of the anode. The reactant gas is ionized by a catalyst material disposed in juxtaposition with the flow field plate or deposited directly on the flow field plate. As a result of the ionization, protons can be conveyed across a proton exchange membrane from the anode to the cathode. The proton exchange membrane conveys positive charge while not allowing the conduction of electrons. (For purposes of this particular patent, it should be understood that use of the term proton exchange membrane is intended to include polymer electrolyte membranes.) The electrons produced by the ionization can be conducted through a circuit from the anode through a load to the cathode. Notably, the fuel cell system shown in FIG. 1 can be implemented with solid silicon substrates that not can be configured as flow field plates but also that can be directly bonded with one another so as to eliminate the need for complicated gasketing that is required in the implementation of carbon based flow field plates.

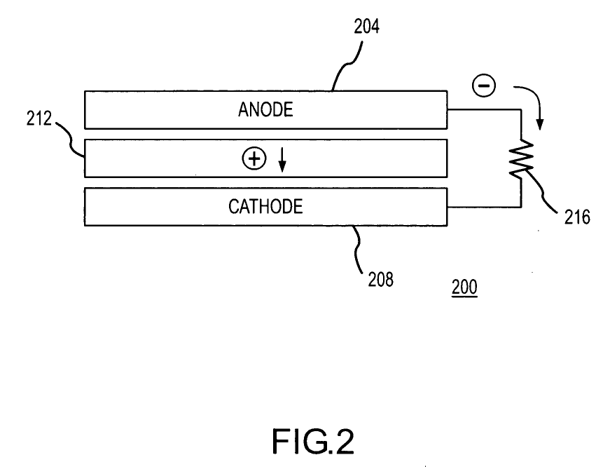

This principle of operation is illustrated in FIG. 2 which shows a system 200 in which protons or positively charged ions move from the anode 204 to the cathode 208 across the membrane 212. FIG. 2 also shows that the electrons are conducted by the conductors through load 216 to cathode 208. At the cathode, a second reactant gas can be distributed across a flow field plate and catalyzed so that it reacts with the positive ions (typically protons) conveyed by the membrane and the electrons conducted across the circuit. End products from the reaction can then be flushed from the flow field plates via a manifold system.

Referring again to FIG. 1, system 100 shows anode 104 and cathode 108. The cross sections of these electrodes illustrates chambers etched in the electrodes through which reactant gases can be introduced and expelled. Furthermore, these cross-sections illustrate protrusions, such as pillars, that can take a variety of shapes. As explained in the priority documents, the protrusions can be used to help distribute the reactant gases effectively and in some embodiments support catalyst material for catalyzing the reactant gases. FIG. 1 also shows a membrane sandwiched between the anode and cathode. The membrane can take a variety of configurations. According to one embodiment a membrane electrode assembly (MEA) can be used. Such a membrane electrode assembly can comprise an electrolyte membrane disposed between two gas diffusion layers. Such MEA's are well known to those of ordinary skill in the art. FIG. 1 illustrates a MEA in which membrane materials 112 and 116 contain an electrolyte material that is capable of conveying positive charge. Catalyst material layers 118 and 120 are shown disposed in juxtaposition with the membrane materials. The catalyst material layers 118 and 120 can be gas diffusion layer material such as carbon fibers that support catalyst particles. Alternatively, they could simply be gas diffusion layers without catalyst material and the catalyst material could be deposited strictly on the flow field plates. FIG. 1 also shows that a metal backing (150 and 142) can be deposited on the back of the flow field plates. This metal backing not only lowers the resistance of the flow field plate for conductance purposes but also facilitates conductive bonding between successive fuel cells in a fuel cell stack. Thus, metal backing layers 141 and 142 and bond 143 illustrate a conductive bond between two successive fuel cells. Finally, FIG. 1 illustrates entry and exit ports for reactant gases. A reactant gas used by the anode can be introduced via input port 160 and byproducts from the reaction at the anode can be exhausted via exit port 162. As one example, hydrogen can be used as the fuel for the anode in a proton exchange membrane fuel cell. Similarly, the cathode provides an input port 170 through which a reactant gas for use at the cathode can be supplied. The byproducts from the cathode reaction can be exhausted via exit port 172. Examples of a reactant gas used by the cathode in a proton exchange membrane fuel cell is oxygen or air.

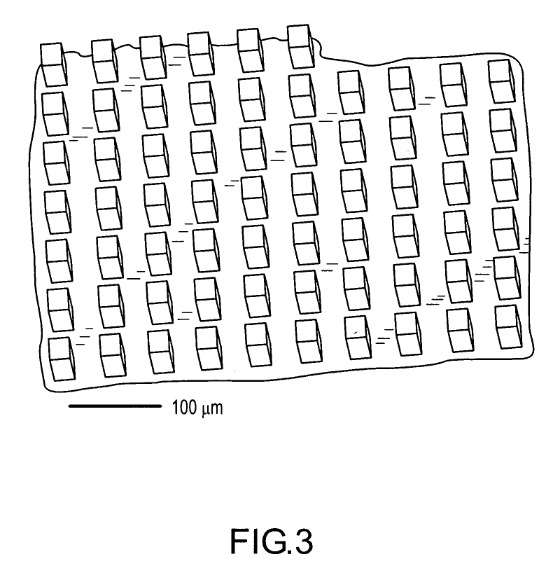

As noted above, the flow field plates used by the fuel cell can be configured from a solid silicon substrate. This silicon substrate can be doped to improve its conductivity or coated with a metal layer, such as gold, or a carbon layer to similarly improve its conductivity. Use of silicon is beneficial as outlined in the priority applications. For example, it allows the silicon wafers to be configured with a high density of protrusions that allow thorough distribution of reactant gases. This is possible with silicon because the silicon wafer can be etched with silicon processing techniques while previous flow field plates made from carbon could not achieve such small scale patterning. FIG. 3 illustrates a perspective view of a flow field plate made from silicon, according to one embodiment. Moreover, the silicon substrate based flow fields can be made from very thin silicon substrates. Thus, the weight and thickness of the flow field plates is reduced. This further reduces the dimensions of the fuel cell. For example, a change from carbon based flow field plates to silicon based flow field plates, significantly reduces the weight and also reduces the height of the fuel cell. Consequently, as fuel cells are stacked on top of one another, the reduction in size of the resulting fuel cell stack can be significant. However, perhaps one of the most significant aspects of changing from carbon based flow field plates to silicon substrate flow field plates is the ability to remove the need for gasketing, as taught by embodiments of the invention disclosed herein. Namely, the silicon is conducive to adhering well in dielectric bonds while carbon is not. Carbon therefore requires gasketing and external compression devices to force the carbon plates against one another to establish a seal of the MEA between two flow field plates. According to one embodiment of the invention, the use of dielectric bonds between two silicon flow field plates allows the flow field plates to sufficiently seal the MEA so as to prevent leakage and eliminates the need for gaskets and external compression devices. Typically, such gaskets operate by being positioned in juxtaposition with a device to be sealed and then expanded by the pressure applied by external compression devices. The pressure causes the gasket to expand into crevices and thus exert a seal. However, such pressures/forces can damage the components being sealed. Furthermore, they typically require manual construction. Such manual construction can be time consuming, expensive, and prone to error.

Referring again to FIG. 1 a cross-section of a dielectric bond can be seen. This cross-section shows dielectric bonding material 130 disposed between anode 104 and cathode 108. The dielectric bonding material electrically insulates the anode from the cathode so as to allow them to be at different electrical potentials during operation of the fuel cell. Notably, the bond can take place directly between the anode and the cathode flow field plates so as to not require intermediary structures. This reduces the cost of construction of the fuel cell. As can be seen in FIG. 1, the dielectric bonding material also establishes a seal to prevent leakage of reactant gases from the anode to the cathode and vice versa. The dielectric bonding material is disposed so as to surround the MEA or other membrane or electrolyte supporting structure and form a non-conductive and gas tight seal around the external boundary of such devices. This prevents any conductance of electrons or positive ions or leakage of reactant gases.

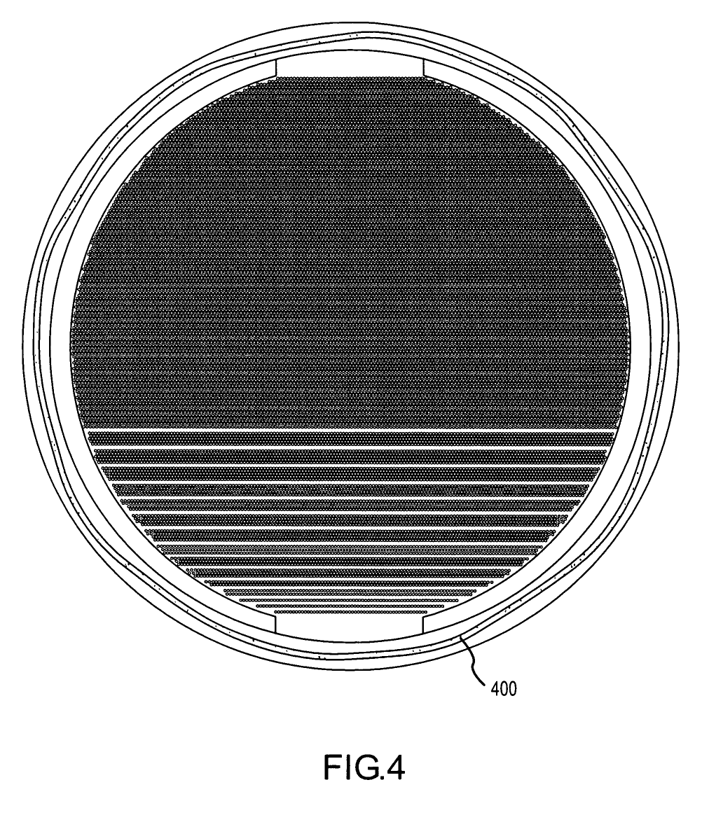

FIG. 4 illustrates a top view of a flow field plate on which a dielectric bonding material can be deposited. As shown, the dielectric bonding material 400 can first be directly deposited on one of the silicon substrate flow field plates while still having a fluid consistency. For example, the dielectric bonding material can be disposed on an outer rim of the flow field plate. The membrane can then be positioned. Then, the second silicon substrate flow field plate can be positioned so as to sandwich the membrane between the two silicon substrate flow field plates. The two silicon substrate flow field plates can then be compressed together so as to cause the fluid bonding material to flow against the membrane and establish a gas-tight seal. Furthermore, the dielectric bonding material should not be compressed to such a degree that the silicon substrate flow field plates are allowed to touch, as that would cause an electrical short during operation of the fuel cell. Rather, the dielectric bonding material should insulate the two flow field plates from one another. Once the dielectric bonding material has been formed into position, it is allowed to cure so as to form a permanent dielectric bond between the flow field plates. It is intended that a “permanent” bond mean a bond that will not be broken under normal operating conditions and is no longer fluid. Thus, such a bond would need to be stable in a temperature environment of about 160 to about 200 degrees Celsius under standard atmospheric pressure. Similarly, such a bond would need to remain stable during normal operation of a fuel cell, such as a proton exchange membrane fuel cell and the typical acidity and humidity conditions of such a fuel cell, as would be appreciated by one of ordinary skill in the art.

While the above method described construction of a single fuel cell, it is noted that an entire fuel cell stack could be fabricated and then pressurized so as to allow dielectric bonds for an entire stack of fuel cells (e.g., a stack of 5-10 cells) to be formed in the same pressurization and curing steps.

One example of a material that can be used to effect the dielectric bond is glass such as that used to establish a glass fritt bond. Liquefied glass can be deposited as the bonding material on one or both flow field plates prior to the plates being pressed together to sandwich the membrane and then allowed to cool so as to form the dielectric bond. Other materials that might be used as the bonding material are non-conductive varieties of silicones, epoxies, acrylics, anaerobic adhesives, hot melts, methacrylates, and polyurethanes. Other non-conductive bonding materials known to those of ordinary skill in the art in the silicon processing industry could be used as well.

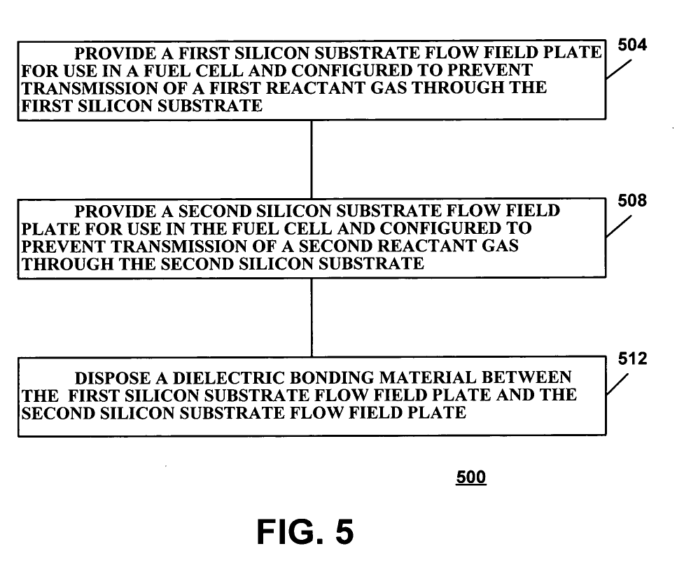

Referring now to FIG. 5, a method of implementing one embodiment of the invention can be seen. Namely, FIG. 5 illustrates a high level flow chart 500 that demonstrates a method of configuring a fuel cell with a dielectric bonding material. This can be accomplished by providing a first silicon substrate flow field plate for use in the fuel cell that is configured to prevent transmission of a reactant gas through the silicon substrate. By configuring the flow field plate to be made of solid silicon substrate, as opposed to a porous silicon, the flow field plate will not allow leakage of reactant gases. This is illustrated in block 504. In block 508, a second silicon substrate flow field plate is similarly configured to allow transmission of a different reactant gas. Furthermore, this flow field plate is also configured so as to be formed from a solid silicon substrate that will not allow the second reactant gas to pass through the silicon substrate other than through manifold openings. It should be noted that solid silicon substrate is intended to encompass doped silicon or silicon covered with conductive material—but does not include a porous silicon that permits reactant gases to escape during operation of the fuel cell. Finally, in block 512, a dielectric bonding material is disposed between the first silicon substrate flow field plate and the second silicon substrate flow field plate.

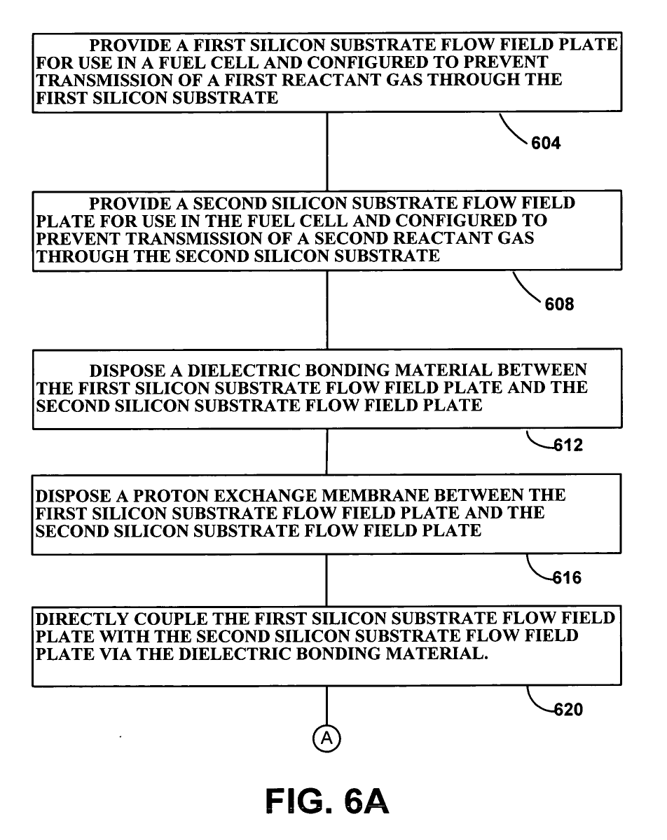

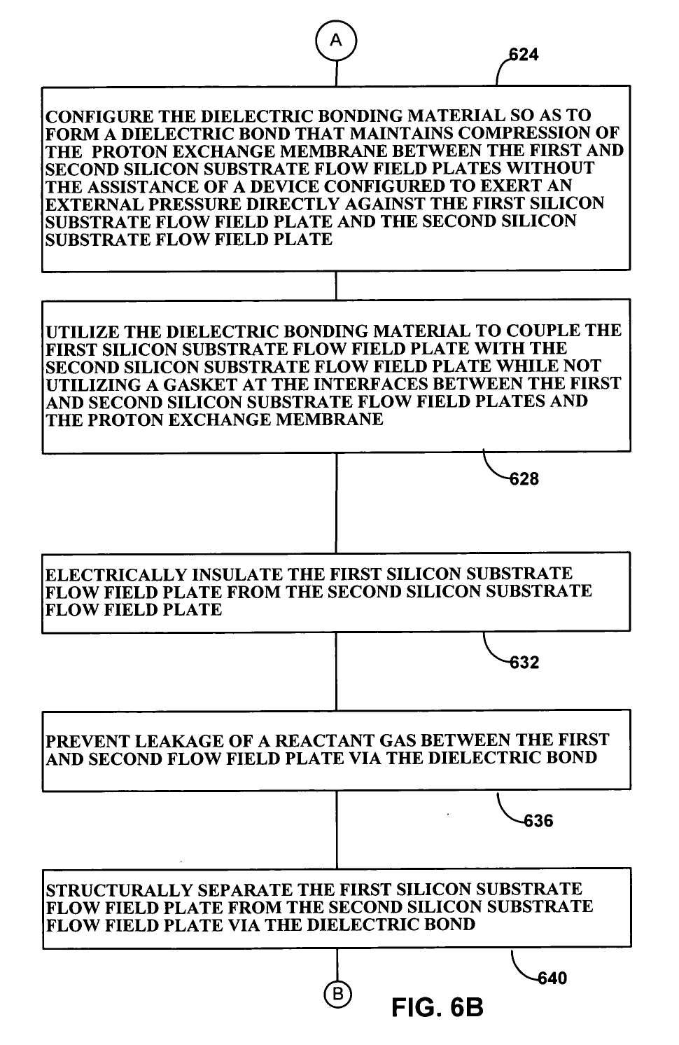

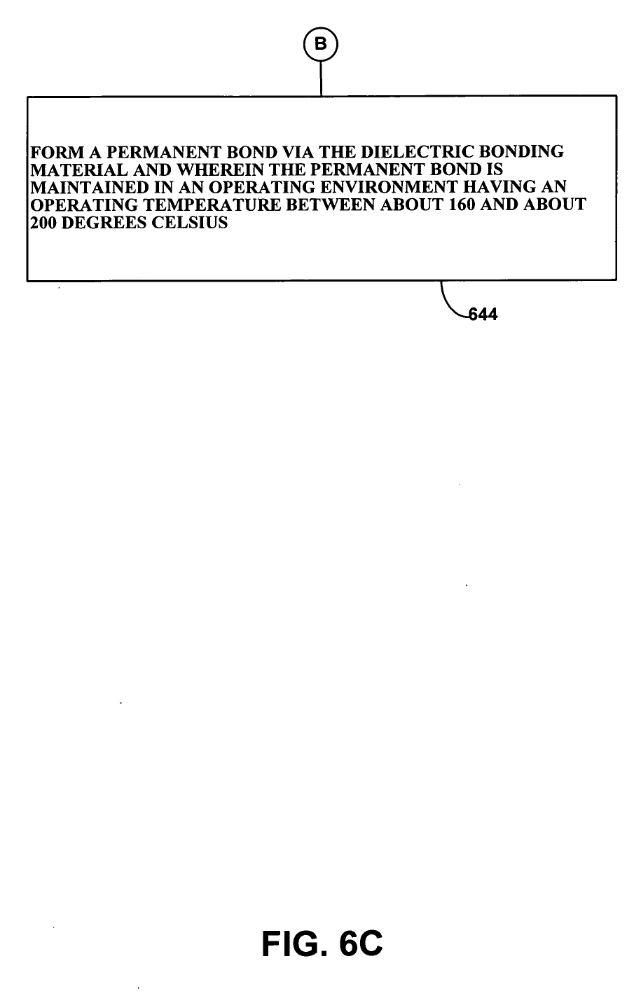

A more detailed embodiment can be seen by referring to FIGS. 6A, 6B, and 6C. These figures illustrate a flow chart 600 that demonstrates a method of configuring a fuel cell in accordance with one embodiment of the invention. Blocks 604, 608 and 612 substantially track the description of blocks 504, 508, and 512. In block 616, a proton exchange membrane can be disposed between the first silicon substrate flow field plate and the second silicon substrate flow field plate. Furthermore, the dielectric bonding material can be used to establish a bond so as to directly couple the first silicon substrate flow field plate with the second silicon substrate flow field plate. As noted earlier, the bond can be established by exerting a pressure against the flow field plates so as to cause the bonding material to form a seal and then curing the bonding material so as to establish a permanent bond. As part of the bonding configuration process, block 624 illustrates that the dielectric bonding material can be configured so as to form a dielectric bond that maintains compression of the proton exchange membrane between the first and second flow field plates without the assistance of a device that is configured to exert an external pressure against the first and second silicon substrate flow field plates. Similarly, block 628 illustrates that the dielectric bonding material can be utilized to couple the first silicon substrate flow field plate with the second silicon substrate flow field plate while not utilizing a separate gasket article of manufacture at the interfaces between the first and second silicon substrate flow field plates and the proton exchange membrane. In addition, block 632 shows that the bond can be used to electrically insulate the flow field plates from one another during operation of the fuel cell. Similarly, block 636 shows that the dielectric bond can be used to prevent leakage of a reactant gas between the flow field plates or around the proton exchange membrane. In addition, the dielectric bond can serve as a structural separator that separates the flow field plates from one another and thus prevents undue pressure on the membrane during use. This is illustrated in block 640. Finally, block 644 illustrates that the bond can be established so as to withstand the operating conditions of a fuel cell, such as a proton exhange membrane fuel cell, that can expose the bond to highly concentrated phosphoric acid in high humidity conditions and temperatures of about 160 to about 200 degrees Celsius.

It is also noted that many of the structures, materials, and acts recited herein can be recited as means for performing a function or steps for performing a function. Therefore, it should be understood that such language is entitled to cover all such structures, materials, or acts disclosed within this specification and their equivalents, including the matter incorporated by reference.

It is thought that the apparatuses and methods of the embodiments of the present invention and its attendant advantages will be understood from this specification. While the above is a complete description of specific embodiments of the invention, the above description should not be taken as limiting the scope of the invention as defined by the claims.

What is claimed is:

1. An apparatus comprising:
a first silicon substrate flow field plate for use in a fuel cell and configured to prevent transmission of a first reactant gas through said first silicon substrate;
a second silicon substrate flow field plate for use in said fuel cell and configured to prevent transmission of a second reactant gas through said second silicon substrate;
a dielectric bonding material disposed between said first silicon substrate flow field plate and said second silicon substrate flow field plate.

2. The apparatus as claimed in claim 1 wherein said dielectric bonding material directly couples said first silicon substrate flow field plate with said second silicon substrate flow field plate.

3. The apparatus as claimed in claim 1 and further comprising a proton exchange membrane disposed between said first silicon substrate flow field plate and said second silicon substrate flow field plate.

4. The apparatus as claimed in claim 3 wherein said dielectric bonding material couples said first silicon substrate flow field plate with said second silicon substrate flow field plate without utilizing a gasket at the interfaces between said first and second silicon substrate flow field plates and said proton exchange membrane.

5. The method as claimed in claim 3 wherein said first silicon substrate flow field plate and said second silicon substrate flow field plate maintain compression of said proton exchange membrane via said dielectric bonding material without the assistance of a device configured to exert an external pressure directly against said first silicon substrate flow field plate and said second silicon substrate flow field plate.

6. The apparatus as claimed in claim 5 wherein said dielectric bonding material electrically insulates said first silicon substrate flow field plate from said second silicion substrate flow field plate.

7. The apparatus as claimed in claim 6 wherein said dielectric bonding material prevents leakage of a reactant gas between said first and second flow field plate.

8. The apparatus as claimed in claim 6 wherein said dielectric bonding material structurally separates said first silicon substrate flow field plate from said second silicon substrate flow field plate.

9. The apparatus as claimed in claim 1 wherein said dielectric bonding material forms a permanent bond and wherein said permanent bond is maintained in a corrosive operating environment.

10. The apparatus as claimed in claim 1 wherein said dielectric bonding material forms a permanent bond and wherein said permanent bond is maintained in an operating environment having an operating temperature between about 160 and about 200 degrees Celsius.

11. The apparatus as claimed in claim 3 wherein said proton exchange membrane comprises an electrolyte layer, a first gas diffusion layer, and a second gas diffusion layer.

12. A method comprising:
providing a first silicon substrate flow field plate for use in a fuel cell and configured to prevent transmission of a first reactant gas through said first silicon substrate;
providing a second silicon substrate flow field plate for use in said fuel cell and configured to prevent transmission of a second reactant gas through said second silicon substrate;
disposing a dielectric bonding material between said first silicon substrate flow field plate and said second silicon substrate flow field plate.

13. The method as claimed in claim 12 and further comprising directly coupling said first silicon substrate flow field plate with said second silicon substrate flow field plate via said dielectric bonding material.

14. The method as claimed in claim 12 and further comprising disposing a proton exchange membrane between said first silicon substrate flow field plate and said second silicon substrate flow field plate.

15. The method as claimed in claim 14 and further comprising utilizing said dielectric bonding material to couple said first silicon substrate flow field plate with said second silicon substrate flow field plate while not utilizing a gasket at the interfaces between said first and second silicon substrate flow field plates and said proton exchange membrane.

16. The method as claimed in claim 14 and further comprising configuring said dielectric bonding material so as to form a dielectric bond that maintains compression of said proton exchange membrane between said first and second silicon substrate flow field plates without the assistance of a device configured to exert an external pressure directly against said first silicon substrate flow field plate and said second silicon substrate flow field plate.

17. The method as claimed in claim 16 and further comprising electrically insulating said first silicon substrate flow field plate from said second silicon substrate flow field plate.

18. The method as claimed in claim 17 and further comprising preventing leakage of a reactant gas between said first and second flow field plate via said dielectric bond.

19. The method as claimed in claim 17 and further comprising structurally separating said first silicon substrate flow field plate from said second silicon substrate flow field plate via said dielectric bond.

20. The method as claimed in claim 12 and further comprising forming a permanent bond via said dielectric bonding material and wherein said permanent bond is maintained in a corrosive operating environment.

21. The method as claimed in claim 12 and further comprising forming a permanent bond via said dielectric bonding material and wherein said permanent bond is maintained in an operating environment having an operating temperature between about 160 and about 200 degrees Celsius.

22. The method as claimed in claim 14 wherein said proton exchange membrane comprises an electrolyte layer, a first gas diffusion layer, and a second gas diffusion layer.
